(19) United States
(12) Patent Application Publication
(10) Pub. No.: US 2009/0125299 A1
(43) Pub. Date: May 14, 2009

(54) Speech recognition system

(76) Inventor: Jui-Chang Wang, Taipei City (TW)

Correspondence Address: TROXELL LAW OFFICE PLLC, SUITE 1404, 5205 LEESBURG PIKE, FALLS CHURCH, VA, 22041, US

(21) Appl. No.: 11/979,947

(22) Filed: Nov. 9, 2007

(51) Int. Cl. G10L 21/06

(52) U.S. Cl. 704/201; 704/E15.001

(57) ABSTRACT

A speech recognition system comprises at least a speech recognition engine and a display device that contains a signal status interface and a textual interface. The signal status interface is used to show a recording status, a speech processing status, or a complete speech recognition status based on waveforms display. The textual interface is used to show word units of the speech recognition results. Two sets of commands are connected with each waveform unit on the signal status interface and each word unit on the textural interface, respectively, in order to allow users to correct the recognition errors or to adjust the speech recognition system.

### BACKGROUND OF THE INVENTION

1. Field of the Invention

The present invention relates to a speech recognition system and, more particularly, to a speech recognition system that is not only able to show graphically the speech recording status, the speech processing status, and the complete speech recognition status by waveforms display, but also able to connect each of the waveforms and texture displays with a command menu. Each command menu contains at least a command for users to correct the speech recognition errors or adjust the speech recognition system. The invention is suitable for electronic devices with graphic interface, such as desktop computers, notebook computers, home multimedia-center systems, television sets, DVD machines, audio or video systems, mobile phones, or personal digital assistants.

2. Description of the Prior Art

The development of speech recognition techniques makes it more convenient for users to operate electronic devices. Conventionally, when using any kind of electronic devices, such as desktop computers, notebook computers, home multimedia-center systems, television sets, DVD machines, audio or video systems, mobile phones, personal digital assistants or others, users usually operate these electronic devices by hands. For example, when users utilize computers, they need to input commands by using a keyboard, a mouse, or other accessory controlling devices by their hands. The input procedure may be simplified by using a touch screen. However, it is still not ideal for users to input by using a touch screen because users still have to use their fingers to press on the screen and the display area on the screen is limited. The problems mentioned above may only cause inconvenience to general users but, however, may make it impossible for handicapped users, users with neuromuscular disorders, or blind users to operate these electronic devices. With respect to these problems, speech recognition technology is one of the promising solutions.

In the application of speech recognition technology, users can input their speech sounds into a speech recognition system by using audio input devices like microphones and the input speech sounds can be converted into corresponding words or be further converted into corresponding operation commands according to the speech recognition results.

Users have to input their speech sounds via the audio input devices before the speech sounds start to be recognized by the speech recognition system. There are many factors that influence the final speech recognition results during the recording and speech recognition processes, such as the quality of the audio input devices, the recording environment, the distance between the users and the audio input devices, and so on. Therefore, it is necessary for users to monitor the quality of recording and speech recognition during the recording and speech recognition processes. Prior arts provide different icons or different shape-changes of an icon for representing the recording status or the speech recognition status. However, it still fails to indicate the success and quality of the recording or speech recognition processes.

In addition, prior arts provide functions for adjusting the speech recognition functions according to the speech recognition results, but their functions are not designed for the word units of the speech recognition results, especially not for the words failed to be recognized correctly in the speech recognition, so that their functions are still not precise to improve the performance of the speech recognition system to approach the specific characteristics of users. Thus, their speech recognition systems are difficult to be made more suitable for each user. For example, users may have their own accents. If the feedback control and the adjustment cannot be made directly on words or terms specifically, it will be difficult to make a speech recognition system highly associated with each user and the efficiency of the speech recognition system will be decreased significantly for accented speakers.

In order to solve the problems mentioned above and make speech recognition able to be adopted more widely, inventor had the motive to study and develop the present invention after hard research to provide a speech recognition system that can be used conveniently and can be adjusted via the feedback and the adjustment made by users according to specific word units in the speech recognition results to make the speech recognition system more suitable for each user.

### SUMMARY OF THE INVENTION

An object of the present invention is to provide a speech recognition system with waveforms display for representing a recording status, a speech processing status, or a complete speech recognition status, by which users can monitor the quality of speech recording, the speed of speech processing, and the confidence levels of the speech recognition results.

Another object of the present invention is to provide a speech recognition system with a correction and adjustment scheme by which users can correct the speech recognition errors or adjust the speech recognition system.

In order to achieve the above objects, the present invention provides a speech recognition system comprising at least a speech recognition engine and a display device that has a signal status interface and a textual interface. The signal status interface is used for showing a recording status, an ongoing speech processing status, or a complete speech recognition status thereon by waveforms display, wherein waveforms are used for representing speech signals from speakers at the same time. The textual interface is used for showing the speech recognition result that includes at least a word unit thereon. Besides, each word unit of the speech recognition results corresponds to a waveform unit in the signal status interface. More importantly, each word unit and each waveform unit are connected with a command menu, respectively, which includes at least a command for users to correct the speech recognition errors or to adjust the speech recognition system.

Preferably, the waveforms are presented in different colors for representing the recording status, the ongoing speech processing status, and the complete speech recognition status respectively.

After the speech signals are completely recognized, the word units of each speech recognition result are presented on the textual interface. Preferably, each waveform unit shown on the signal status interface and each word unit shown on the textual interface are aligned with each other and both are presented in the same color which indicates the recognition confidence level of the word unit. There are three categories of recognition confidence levels, including good quality, mediocre quality, and bad quality in which condition speech recognition results should be noticed and probably be corrected. These categories of quality are presented in different colors.

The textual interface is connected with a command menu that includes at least a command for users to correct the recognition errors or adjust the speech recognition system.

The waveform unit is connected with a command menu that includes at least a command for users to listen to the recoded speech sound, to re-record the sound, to correct the recognition errors, or to adjust the speech recognition system.

The following detailed description, given by way of examples and not intended to limit the invention solely to the embodiments described herein, will be understood best in conjunction with the accompanying drawings.

### BRIEF DESCRIPTION OF THE DRAWINGS

FIG. 1 shows a schematic view of a speech recognition system of the present invention.

FIG. 2 is a schematic view of a first embodiment of a speech recognition system of the present invention.

FIG. 3 is another schematic view of the first embodiment of the speech recognition system of the present invention.

FIG. 4 is another schematic view of the first embodiment of the speech recognition system of the present invention.

FIG. 5 shows a using-state diagram of the first embodiment of the speech recognition system of the present invention.

FIG. 6 is another using-state diagram of the first embodiment of the speech recognition system of the present invention.

### DETAILED DESCRIPTION OF THE PREFERRED EMBODIMENTS

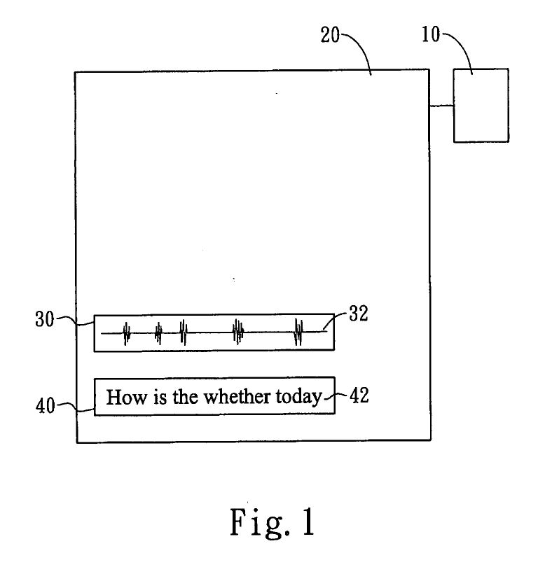

FIG. 1 is a schematic view of a speech recognition system according to the present invention. The speech recognition system according to the present invention comprises at least a speech recognition engine 10 and a display device 20. The display device 20 has a signal status interface 30 and a textual interface 40 thereon. The signal status interface 30 is used for showing a recording status, an ongoing speech processing status, or a complete speech recognition status by using a waveform that represents speech signals from a speaker. The textual interface 40 is used for showing the speech recognition result including at least a word unit. As shown in FIG. 1, the waveform 32 shown on the signal status interface 30 is to represent the input speech signals of users and the word units shown on the textual interface 40 is of the speech recognition result 42. The word unit can be a sub-word, a word, or a phrase. In this embodiment, each word unit corresponds to a word 420. Moreover, the display device 20 of the speech recognition system of the present invention can be a display for any electronic devices, such as desktop computers, notebook computers, home multimedia-center systems, television sets, DVD machines, audio or video systems, mobile phones, or personal digital assistants.

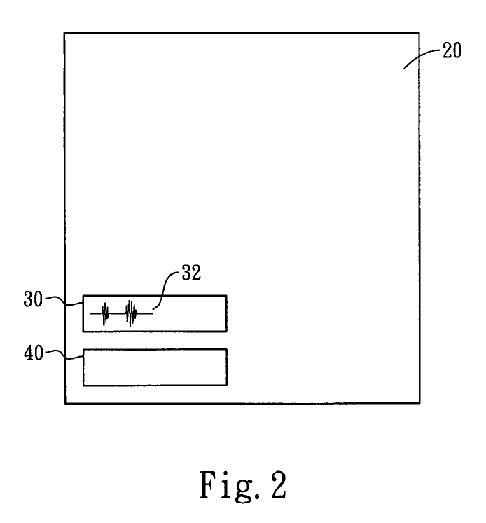

FIG. 2 is a schematic view of a first embodiment of a speech recognition system of the present invention for showing a recording status of the system. As shown in FIG. 2, a user inputs speech signals into the speech recognition system by means of an audio input device, like a microphone (not shown in this figure). The input speech signals are shown on a signal status interface 30 as a waveform 32. The use of a waveform is advantageous in two aspects. First, the user can know whether the recording process successfully starts by noticing if there appears any undulated presentation of the waveform. The speech signals of the user may fail to be input correctly during the recording process due to several reasons. For example, the speech signals may fail to be input because the audio input device is not activated, or it is out of work, or even it has no correct electrical connection with the electronic device of the speech recognition system. Under these situations, the user of the system is able to find immediately an unsuccessful recording when its waveform is wrong. It is timesaving for the user to find the problem visually in the beginning of the recording and the user can react to it immediately. Second, users can judge the quality of the input speech signals on the basis of the shape of the waveform. If the quality of the input speech signals is poor, users can make some appropriate adjustments. The factors that may influence the recording quality include environmental noise interference, the sensitivity of the audio input device, the way that users utilize the audio input device, and so on. If users can control, manage, or even eliminate these factors during recording process, not only the quality of the input speech signals can be improved, but also the operation of the speech recognition can be significantly beneficial.

As mentioned above, the signal status interface 30 according to the present invention is used for showing the recording status and the speech recognition status by using a waveform 32. The speech recognition status includes an ongoing speech processing status and a complete speech recognition status. In addition, the recording status, the ongoing speech processing status, and the complete speech recognition status are presented in different colors to visually represent the progress of speech recognition processes. When the speech sound is input by a speaker, the waveform of the current input speech is displayed in the color of the recording status. After the speech recognition process is started, part of the waveform is gradually replaced by the color of the ongoing speech processing status. When the whole recorded speech sound is processed completely, its waveform is drawn in colors of the complete speech recognition status: some word units are drawn in the color of high confident recognition quality, some in the color of mediocre quality, and some in the color of bad quality. Accordingly, users can know visually more information of the system, including what the current status is, the quality of speech recognition, and the processing speed.

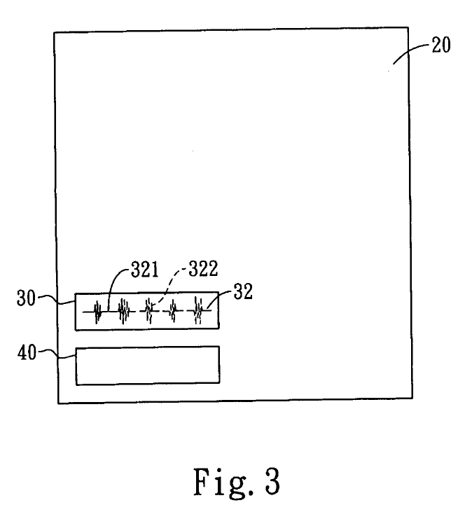

When the input speech signals are still being recognized, the recognized and un-recognized parts of a waveform 32 shown on the signal status interface 30 are presented in different colors. As shown in FIG. 3, solid line as one color is used for representing recognized part of the waveform 321 while dashed line as the other color is used for representing un-recognized part of the waveform 322. When the speech recognition is complete, the whole waveform will be presented in new colors, which will be described later.

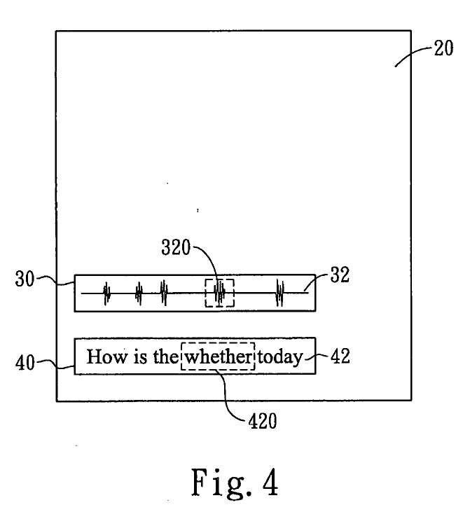

When the speech signals input by users are completely recognized, the best candidate words 420 of the speech recognition result 42 corresponding to the speech signals are shown on the textual interface 40. As shown in FIG. 4, the waveform 32 that represents the speech signals input by users includes at least a waveform unit 320 and each waveform unit 320 corresponds to a word 420 of the speech recognition result 42. Each waveform unit 320 shown on the signal status interface 30 and each word 420 shown on the textual interface 40 are aligned with each other in parallel. In this embodiment, each waveform unit 320 corresponds to a word 420 of the speech recognition result 42. Referring to FIG. 4, what a user inputs is the speech signals of “How is the weather today” and the words of the speech recognition result are “How is the weather today”. In this example, the word of the speech recognition result “weather” 420 corresponds to one waveform unit 320, and both are aligned in parallel and displayed in the same color that indicates the recognition confidence level of the word “weather”.

When the speech recognition system is involved in speech understanding applications, the words of the speech understanding result are also shown on the textual interface 40, while the way of waveforms display is unchanged on the signal status interface 30. Besides, the words of the speech recognition result can also be shown on the textual interface 40 directly, or be hidden by default but be shown thereon only after users select the choice of presenting the result.

Also referring to FIG. 4, each waveform unit 320 on the signal status interface 30 corresponds to and is in parallel aligned with each word 420 on the textual interface 40. Each word is presented in one of a set of certain colors that represents the confidence level of speech recognition quality of that word. In this embodiment, each word can be presented in red, yellow, or green color. The green color indicates that the confidence level of speech recognition of the word is of good quality; the yellow color indicates that the confidence level of speech recognition of the word is of mediocre quality; and the red color indicates that the confidence level of speech recognition of the word is of bad quality so that the word should be noticed and probably be corrected. Therefore, users can perceive the confidence level of speech recognition results visually and make some suitable adjustments correspondingly.

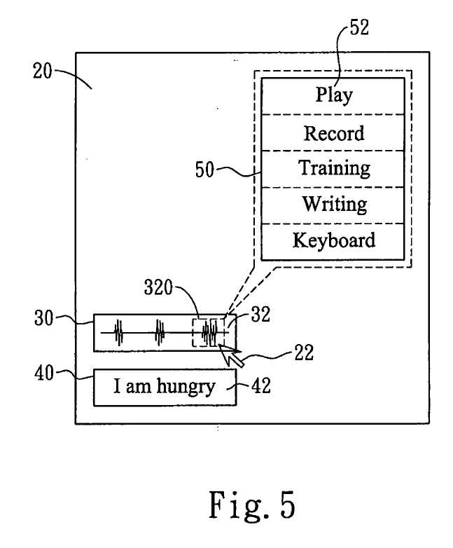

Moreover, each waveform unit is connected with a command menu that has at least a command for users to check the input speech sounds, re-record the speech sounds, correct the speech recognition errors, or adjust the speech recognition system. As shown in FIG. 5, each waveform unit 320 is connected with a command menu 50 that includes at least a command 52. In this embodiment, the command menu 50 includes commands 52 of “Play”, “Record”, “Train”, “Writing”, and “Keyboard”. After the speech recognition is complete, users can initiate the command menu 50 on the display device 20, as well as further choose any command 52 from it, by moving a mouse cursor to one waveform unit 320 or by pressing directly the waveform unit 320 on a touch panel.

For example, if a user finds that the waveform 32 is in peculiar shape, the user can select the command “Play” 52 to listen to the recorded speech signals and judge whether there is any noise interference in the recording process. Or, users can find out the reasons why the words in the speech recognition results are incorrect, such as a pronunciation problem. If the recorded speech sounds are clean but with pronunciation deviations from general cases, the user can select “Record” to re-record the sound or select “Train” to adjust the system to improve the accuracy of the specific word for the users. Before the speech recognition system is able to correctly recognize the input speech sounds of the users, sometimes they also can select the command “Writing” or “Keyboard” to switch a speech input mode into a handwriting mode or a keyboard input mode to correct the errors and complete the input task.

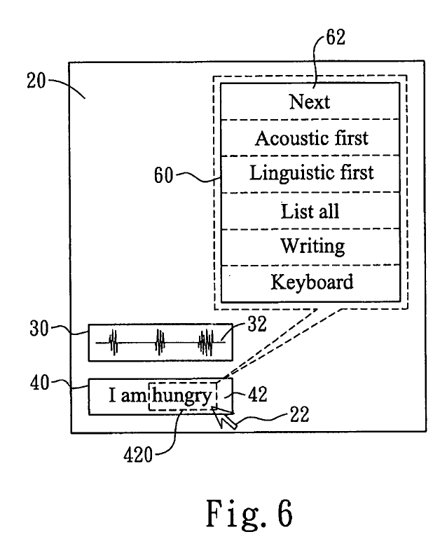

Each word 420 in the speech recognition result is connected with a command menu that has at least a command for users to correct speech recognition errors or to adjust the speech recognition system. As shown in FIG. 6, each word 420 is connected with a command menu 60 that includes at least a command 62. In this embodiment, the command menu 60 includes commands 62 of “Next”, “Acoustic first”, “Linguistic first”, “List all”, “Writing”, and “Keyboard”. After the speech recognition is complete and words 420 of the speech recognition results are shown on the textual interface 40, users can initiate the command menu 60 on the display device 20, as well as choose a command from it, by moving a mouse cursor to one word 420 or by pressing directly the word 420 on a touch panel.

Furthermore, the reason why the words of the speech recognition results are incorrect may be due to the pronunciation deviations of the user. As shown in FIG. 6, the correct words corresponding to the input speech signals may be “I am hungry”, but the words of the speech recognition results shown on the textual interface 40 could be quite different. According to the speech recognition system of the present invention, a plurality of candidate words in the speech recognition results is provided for users to select. Users can determine the speech recognition result by selecting the commands 62 in the command menu 60. For example, users can obtain the next best candidate word in the speech recognition result by selecting the command “Next” 62, obtain the best candidate word in the speech recognition result with respect to only the acoustic scores of the waveform unit 320 by selecting the command “Acoustic first” 62, obtain the best candidate word in the speech recognition result with respect to only the adjacent words and the linguistic knowledge by selecting the command “Linguistic first” 62, or list all possible candidates in the speech recognition result by selecting the command “List all” 62. Users may also have other choices of commands “Writing” or “Keyboard” to switch a speech input mode into a handwriting mode or a keyboard input mode to complete the input task.

Thereby, the present invention has the following advantages:
1. By means of the waveforms display of the input speech signals in the speech recognition system according to the present invention, users can immediately judge whether the recording is successfully started and identify how the quality of the input speech is by looking at the signal waveforms.
2. By means of changing the color of the waveforms display in the speech recognition system of the present invention, users can conveniently monitor the speech processing status and the confidence levels of the words in the speech recognition results.
3. By means of the attached command menus over the waveforms 320 and words 420 in the speech recognition system of the present invention, users can correct the recognition errors or adjust the speech recognition system for some words so that the speech recognition accuracy can be improved continuously.

Accordingly, as disclosed in the above description and attached drawings, the present invention can provide users with a speech recognition system that can be easily monitored whether the recording proceeds successfully, the quality of input speech signals, the speech processing status, and the confidence levels of speech recognition results. Users can also conveniently correct the recognition errors and adjust the speech recognition system to improve its accuracy. The invention is novel and can be put into industrial use.

It should be understood that different modifications and variations could be made from the disclosures of the present invention by the people familiar in the art, which should be deemed without departing the spirit of the present invention.

What is claimed is:

1. A speech recognition system, comprising at least a speech recognition engine and a display device, which includes:
a signal status interface showing a recording status, an ongoing speech processing status, or a complete speech recognition status by a waveform that represents the speech signal input by a speaker; and
a textual interface showing speech recognition results including at least a word unit.

2. The speech recognition system as claimed in claim 1, wherein the word unit is a sub-word, a word, or a phrase.

3. The speech recognition system as claimed in claim 1, wherein the waveforms of the recording status, the ongoing speech processing status, and the complete speech recognition status are presented in different colors.

4. The speech recognition system as claimed in claim 1, wherein each word unit shown on the textual interface is presented in one of a set of colors that represent the confidence levels of the speech recognition results.

5. The speech recognition system as claimed in claim 4, wherein each word unit is presented in green, yellow, or red color: The green color indicates the confidence level of the word unit to be good quality; the yellow color indicates the confidence level of the word unit to be mediocre quality; and the red color indicates the confidence level of the word unit to be bad quality in which condition the speech recognition result should be noticed and probably be corrected.

6. The speech recognition system as claimed in claim 4, wherein each word unit shown on the textual interface is connected with a command menu that includes at least a command for users to correct the recognition errors or adjust the speech recognition system.

7. The speech recognition system as claimed in claim 6, wherein the command menu for users to correct the recognition errors or adjust the speech recognition system is initiated and presented on the display device by moving a mouse cursor shown on the display device onto a word unit or by pressing the word unit on a touch panel.

8. The speech recognition system as claimed in claim 6, wherein the commands in the command menu are selected from a group of commands including to list the next best candidate, to list the best acoustic-first candidate, to list the best linguistic-first candidate, to list all possible candidates, to switch to a handwriting input mode, and to switch to a keyboard input mode.

9. The speech recognition system as claimed in claim 4, wherein the waveform of the complete speech recognition status on the signal status interface further includes at least a waveform unit that is corresponding to a word unit of the speech recognition result on the textual interface, and each waveform unit is aligned in parallel on the screen with its corresponding word unit, and both units are presented in the same color that shows the confidence level of the word unit in the speech recognition result.

10. The speech recognition system as claimed in claim 9, wherein each waveform unit is connected with a command menu that includes at least a command for users to listen to the recoded speech sound, to re-record the sound, to correct recognition errors, or to adjust the speech recognition system.

11. The speech recognition system as claimed in claim 10, wherein the command menu that contains commands for users to correct the recognition errors or to adjust the speech recognition system is initiated and presented on the display device by moving a mouse cursor shown on the display device to a waveform unit or by pressing the waveform unit on a touch panel.

12. The speech recognition system as claimed in claim 10, wherein the commands in the command menu are selected from a group of commands including to play, to record, to train, to switch to a handwriting input mode, and to switch to a keyboard input mode.

13. The speech recognition system as claimed in claim 5, wherein the waveform of the complete speech recognition status on the signal status interface further includes at least a waveform unit that is corresponding to a word unit of the speech recognition result on the textual interface, and each waveform unit is aligned in parallel on the screen with its corresponding word unit, and both units are presented in the same color that shows the confidence level of the word unit in the speech recognition result.

14. The speech recognition system as claimed in claim 13, wherein each waveform unit is connected with a command menu that includes at least a command for users to listen to the recoded speech sound, to re-record the sound, to correct recognition errors, or to adjust the speech recognition system.

15. The speech recognition system as claimed in claim 14, wherein the command menu that contains commands for users to correct the recognition errors or to adjust the speech recognition system is initiated and presented on the display device by moving a mouse cursor shown on the display device to a waveform unit or by pressing the waveform unit on a touch panel.

16. The speech recognition system as claimed in claim 14, wherein the commands in the command menu are selected from a group of commands including to play, to record, to train, to switch to a handwriting input mode, and to switch to a keyboard input mode.

17. The speech recognition system as claimed in claim 1, wherein the speech recognition system is used in a desktop computer, a notebook computer, a home multimedia-center system, a television set, a DVD machine, an audio or video system, a mobile phone, or a personal digital assistant that has a display screen, a connection to a display screen, or a remote controller with a display screen on it.
